(19) United States
(12) Patent Application Publication
(10) Pub. No.: US 2005/0076342 A1
(43) Pub. Date: Apr. 7, 2005

(54) System and method for application sharing

(75) Inventors: Mark Levins, Swords (IE); Bill Looby, Rathfarnam (IE); Michael Roche, Dublin (IE)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/843,068

(22) Filed: May 11, 2004

(30) Foreign Application Priority Data
Oct. 1, 2003 (GB) 0322915.0

(51) Int. Cl. G06F 9/00

(52) U.S. Cl. 719/313

(57) ABSTRACT

A system (100) and method for application sharing based on automatic translation by: running an application in a source language (310), automatically translating (210) at least part of the application from the source language to a target language, and sharing (110) the application in the target language (320). Interception of the application occurs at as high as possible a level so that text methods can be intercepted. The translation may use translation memory (230), machine translation (240) or a combination of these with human translation (250). The sharing may be performed by Windows™ application sharing (120), Java™ application sharing (130), web server redirection (140) or web browser redirection (150). This provides the following advantage(s): An application sharing system can be used, with a link to an automated translated system (either translation memory or machine translation depending on the usage) such that the remote/copy version of the application appears translated. This remote/copy version can be either local to a single machine or displayed remotely with a system such as sametime. It can also apply to web sites, applied locally or from the server.

### FIELD OF THE INVENTION

This invention relates to sharing and automatic translation of software applications.

### BACKGROUND OF THE INVENTION

In the field of this invention automatic translation of software applications is known from a variety of sources. For example:
It is known to allow the dynamic translation of all standard Windows™ menu terms (e.g., File\New, Edit\Find, etc.) and possibly dialogs, so that products can be viewed ‘semi-localized’ to at least allow basic usage in other languages. However, this known dynamic translation did not involve application sharing.
World-wide-web based preview is a common requirement and most content management systems provide it, e.g.:
   The WPCP (WebSphere™ Portal Content Publisher) from IBM® uses URL (Uniform Resource Locator) rewriting to aid preview
   Globalization Management Systems (e.g., ‘GlobalSight System 4’ see website at www.globalsight.com, or ‘Idiom WorldServer’—see website at www.idiomtech.com) generally also offer this functionality.
   Translation of a web page has been provided by AltaVista™ (see website at www.altavista.com) & Google™ (see website at www.google.com) amongst others.

Some Java™ sharing (or at least observation) is provided by JOSIT (Java Observation Simulation Inspection Toolkit—see website at www.openchannelsoftware.org/projects/JOSIT), although this is designed for application monitoring and performance tuning and it does not extend to application sharing.

The JASMINE (Java Application Sharing in Multiuser INteractive Environments) system (see document at web address www.el-saddik.org/jasmine.pdf) provides a level of Java™ application sharing, but does not facilitate translation.

However, these known approaches have a number of disadvantage(s):

1. Translated Windows/Java application product QE (Quality Evaluation) normally requires a product rebuild. Products such as TRADOS (see website at www.trados.com) can provide UI (User Interface) preview, but not a full functional preview.

2. Shared conferences, e.g., using Lotus™ Translation Services for Sametime™ (L TSS) for chat, are able to share only single language (i.e., not translated) versions of presentations.

3. Heretofore it has not been possible to use or demonstrate a new untranslated product in another language.

A need therefore exists for a system and method for application sharing based on automatic translation wherein the abovementioned disadvantage(s) may be alleviated.

### STATEMENT OF INVENTION

In accordance with a first aspect of the present invention there is provided a system for application sharing based on automatic translation as claimed in claim 1.

In accordance with a second aspect of the present invention there is provided a method for application sharing based on automatic translation as claimed in claim 11.

### BRIEF DESCRIPTION OF THE DRAWING(S)

One system and method for application sharing based on automatic translation incorporating the present invention will now be described, by way of example only, with reference to the accompanying drawing(s), in which:

FIG. 1 shows a block schematic diagram of an application sharing scheme based on automatic translation.

### DESCRIPTION OF PREFERRED EMBODIMENT(S)

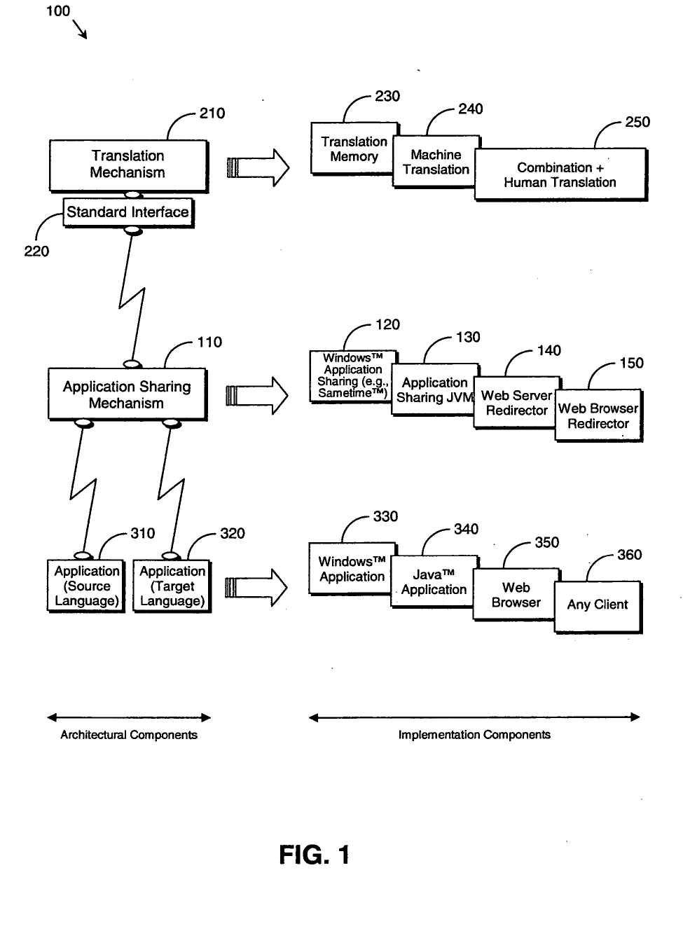

Referring to FIG. 1, a networked computing system 100 includes an application sharing mechanism 110, and a translation mechanism 210 which allow a software application 310 in a source language to be shared as an application 320 in a target language. It will be understood that the previously-recited components represent architectural components, which in practice may be implemented in various forms, as desired, as will be described in greater detail below.

Application Sharing

Application sharing technology per se is not new and several commercial systems (such as Sametime™ and VNC—Virtual Network Computing) exist already. The key in the application sharing mechanism 110 is to intercept at as high as possible a level (image reproduction is not sufficient) so that text methods can be intercepted. The key platforms and approaches per platform are:
Windows™ application sharing (e.g., Sametime™) 120: ‘textout( )’ calls and all window text based funtionality (menu, window title, etc.) would be intercepted, at a level sufficient to support text output. An important consideration here is the use of a high enough call intercept, so that the text will initiate an appropriate resizing where possible.
JVM (Java™ Virtual Machine) application sharing 130: Java™ (‘Swing’—lightweight GUI components in Java Foundation Classes—and ‘AWT’—Abstract Window Toolkit) offers a number of ways for implementation, of which two in particular are:
   Usage of the Java Events Delegation Model (see the prior art JASMINE system referred to above), concentrating on interception at a level appropriate for text substitution.
   Replacement of the standard Java™ UI (User Interface) libraries (both ‘AWT’ & ‘Swing’) with libraries that provide intercept capabilities at a high enough level for text substitution, with automatic resize/layout (i.e., all ‘setText’ methods of components).
Web server redirector 140:
A trigger can be defined to cause text interception at a server level (probably for a given user), with transmission to a different browser window (for application sharing) or the same browser window (for application translation). The actual trigger is unimportant, but may for example be a cookie (i.e., user driven selection), or even the automatic recognition of an unsupported user language. This means that the user can interact with the server in the ‘translated’ language (as will be explained in greater detail below) rather than simply see a copy of the source interaction but in the translated language.
Web browser redirector 150:
A browser plugin approach is proposed, where HTML can be easily intercepted and redirected to another browser. An issue, however, may arise with complicated JavaScript which can
   dynamically modify the viewed area based on existing content
   retrieve new content for display directly.
Windows™ application sharing (above) should however be sufficient for this requirement, for extremely complicated HTML (HyperText Markup Language). Simple HTML redirecting should be sufficient for more dynamic use of a web page (as this would enable greater UI interaction—though not interaction with a server as described above).
   Translating

An important part of the system 100 is implementation of a standard translation interface 220 for fast translations from any source by the translation mechanism 210 (as this is ‘live’, human translation is unlikely to be appropriate, but an exception is discussed below). A single interface should be used to achieve this, regardless of the translation type used. It can be thought of as a ‘translation server’ that provides translation functionality to any of the above platforms.

The translation mechanism can be implemented as translation memory 230, machine translation 240 or a combination 250 of translation memory 230 and machine translation with human translation.

Translation memory 230 has particular application to QE, where a product has been translated, and a review of the translations as seen ‘in-product’ is desired (as discussed below). Access to the particular associated Translation Memory is made available to whichever of the appropriate technologies above is being used.

Machine translation 240 is more likely to be used for ‘gist’ translation of content/product, especially for presentations/demo's.

A combination 250 of translation memory and machine translation with human translation may be used in interactive systems (e.g., forum/tech support above), in which it would make sense to combine Translation Memory with a process for providing additional translation requirements. Initially translations could be provided by Machine Translation, with requirements for ‘real’ translations being sent off to Human Translation for more accurate work. This would be returned in Translation Memory for future use. An important point here is that as this is a dynamic system, once returned (into the Translation Memory) these translations would be used the next time a forum, for example, is accessed.

Thus, by interaction with the application sharing mechanism 110 and the translation mechanism 210 as described above, an application in source language 310 can be shared in a target language 320 between: a Windows™ application 330, a Java™ application 340, a web browser 350 or any other desired client 360.

It will be understood that the system 100 described above, facilitates the following uses.

Product Translation QE

Most product translation is done by translating to a translation memory which then requires a ‘rebuild’ to create a translated product. As web sites are largely composed (rather than raw HTML) this ‘rebuild’ process applies also to web content. As the rebuild is quite often a complicated or server hosted process (e.g., product compilation, or web database update), it can be quite difficult for translators to see translation ‘in-place’. Translation on a shared application basis however requires only the ability to run the application (e.g., log on to a web page) and share it, with the sharing being intercepted by the ‘translation server’.

Automatic Presentation Translation

For e-conferences, there is already support for instant-messaging translation (via LTSS—Lotus™ Translation Services for Sametime™—allowing a ‘Machine Translator’ to be invited to an Instant Messaging conversation, resulting in both the original and translated text being forwarded to the recipient). If presentations/demos could also be translated automatically (via machine translation), it would greatly increase the potential for cross-language presentations. In scenarios where live presentation translation is done (e.g., European Union presentations or technical demo's in many non-English speaking countries), it could also be extremely useful.

Product Demo's/Usage

As most products do not have translated versions available in the early stages, it would be useful to be able to hook up either Machine Translation or Translation Memory (if someone is willing to provide the translations) to display an early version product in another language.

Web Site Translation QE (Local)

As web sites are largely composed (rather than just raw HTML) a ‘rebuild’ process often applies to modifying web content. As the rebuild is quite often a complicated or server hosted process (e.g., site compilation, or web database update), it can be quite difficult for translators to see translation ‘in-place’. Translation on a shared application basis, however, requires only the ability to run the application (e.g., log on to a web page) and share it, with the sharing being allied to the local translation memory.

Web Site Usage (Local)

As above, but for usage rather than just QE. As translation memories are less likely to exist, machine translation is likely to be more appropriate.

Web Application Translation (Server)

This architecture also provides for the server based provision of translated content by web-servers (such as the BabelFish™ facility provided by Alta Vista™). Although technically this might not be considered conventionally as application sharing, it does retain the property that the original source is never modified. In fact in this implementation, no ‘persistent’ version of the translation is ever kept (except in Translation Memory/Machine Translation implementations as described above).

However, the server may usefully be configured to ‘fire’ a separate translated version to an additional browser (thus sharing the application, rather than simply translating to the current browser).

It is will be noted that in all of the above implementations, apart possibly from server based translation, application sharing is used, meaning that the original application is still available for reference. This improves the ability to resolve ambiguities (as opposed to attempting to directly translate the original product/content).

It will further be understood that the examples described above can be extended in the following ways.

1. Use of Context

Clearly in any translation environment, the use of context to improve translation accuracy can help hugely. Especially in the case of QE review using translation memory. A scheme for including context appropriate at the point of translation (e.g., Dialog & Control ID for Windows™ Application sharing), would be a huge benefit.

2. Reverse Translations for the Server

In the case of interactive web applications, translation of incoming data might be useful (i.e., reverse translation). This could help enable a multilingual bulletin board (if control languages were used to minimise ambiguity), or at least tech-support type question submission,

3. Formatting for BiDirectionality

Where possible/relevant, it would make sense to modify formatting information also to provide BiDirectional (e.g., Hebrew/Arabic) layout.

4. On Demand Service for All Platforms

The application sharing capability could be offered as a server based service (e.g., similar to—or even an extension of—Sametime™), that would perform translations from the server but provide plugins (or equivalent) for application sharing.

It will be understood that the system and method for application sharing based on automatic translation described above provides the following advantages.

An application sharing system can be used, with a link to an automated translated system (translation memory, machine translation, or a combination, depending on the usage) such that the remote/copy version of the application appears translated. This remote/copy version can be either local to a single machine or displayed remotely with a system such as Sametime™. It can also apply to web sites, applied locally or from the server.

1. A system for application sharing comprising:
means for running an application in a source language;
means for automatically translating at least part of the application from the source language to a target language; and
means for sharing the application in the target language.

2. The system of claim 1 wherein the means for translating comprises translation memory for storing the at least part of the application translated into target language.

3. The system of claim 1 wherein the means for translating comprises means for performing machine translation of the at least part of the application from the source language to a target language.

4. The system of claim 1 wherein the means for translating comprises means for combining translation memory and machine translation with human translation for translating the at least part of the application from the source language to the target language.

5. The system of claim 1 wherein the means for sharing the application comprises Windows™ application sharing means.

6. The system of claim 1 wherein the means for sharing the application comprises Java™ application sharing means.

7. The system of claim 1 wherein the means for sharing the application comprises server based web application sharing means.

8. The system of claim 1 wherein the means for sharing the application comprises client based web application sharing means.

9. The system of claim 8 wherein the application in the source language is arranged to run in a first browser and the web application sharing means is arranged to share in a second browser the application in the target language.

10. The system of claim 1 wherein the system is arranged to perform one of A-G:

| | |
|---|---|
| A | product translation quality evaluation, |
| B | automatic presentation translation, |
| C | Product Demonstration, |
| D | Product Usage, |
| E | web site translation quality evaluation, |
| F | web site usage, |
| G | web application translation. |

11. A method for application sharing comprising:
running an application in a source language;
automatically translating at least part of the application from the source language to a target language; and
sharing the application in the target language.

12. The method of claim 11 wherein the step of translating comprises using a translation memory for storing the at least part of the application translated into target language.

13. The method of claim 11 wherein the step of translating comprises performing machine translation of the at least part of the application from the source language to a target language.

14. The method of claim 11 wherein the step of translating comprises combining translation memory and machine translation with human translation for translating the at least part of the application from the source language to the target language.

15. The method of claim 11 wherein the step of sharing the application comprises performing Windows™ application sharing.

16. The method of claim 11 wherein the step of sharing the application comprises performing Java™ application sharing.

17. The method of claim 11 wherein the step of sharing the application comprises performing server based web application sharing.

18. The method of claim 11 wherein the step of sharing the application comprises performing client based web application sharing.

19. The method of claim 8 wherein the step of running the application in the source language comprises running the application in a first browser and the step of sharing the application in the target language comprises running in a second browser the application in the target language.

20. The method of claim 11 wherein the method comprises performing one of A-G:

| | |
|---|---|
| A | product translation quality evaluation, |
| B | automatic presentation translation, |
| C | Product Demonstration, |
| D | Product Usage, |
| E | web site translation quality evaluation, |
| F | web site usage, |
| G | web application translation. |
